(19) United States
(12) Patent Application Publication
(10) Pub. No.: US 2023/0045059 A1
(43) Pub. Date: Feb. 9, 2023

(54) MULTIPURPOSE ASSEMBLY-TYPE VEHICLE AND METHOD FOR OPERATING SAME

(71) Applicants: Hyundai Motor Company, Seoul (KR); Kia Corporation, Seoul (KR)

(72) Inventors: Dong Eun CHA, Hwaseong-si (KR); Sang Heon LEE, Seoul (KR); Jin Ho HWANG, Cheonan-si (KR)

(73) Assignees: Hyundai Motor Company, Seoul (KR); Kia Corporation, Seoul (KR)

(21) Appl. No.: 17/728,426

(22) Filed: Apr. 25, 2022

(30) Foreign Application Priority Data
Aug. 5, 2021 (KR) 10-2021-0102958

(51) Int. Cl. B62D 63/02; H01R 13/514; H01R 13/518; B60R 16/02; B60L 1/00

(52) U.S. Cl. CPC B62D 63/025; H01R 13/514; H01R 13/518; B60R 16/02; B60L 1/00; H02J 2310/40

(57) ABSTRACT

The present disclosure relates to an assembled vehicle and introduces a multipurpose assembly-type vehicle comprising: a chassis module comprising multiple floor parts constituting a lower portion of the vehicle, each floor part being able to exchange electric power or data with an adjacent floor part when fastened to each other; and a cabin module comprising multiple cabin parts constituting an upper portion of the vehicle, each cabin part being fastened to a corresponding floor part of the lower portion so as to form an indoor space, and each cabin part being able to exchange electric power or data with the floor part or with another cabin part adjacent thereto.

### CROSS REFERENCE TO RELATED APPLICATION

The present application claims priority to Korean Patent Application No. 10-2021-0102958, filed Aug. 5, 2021, the entire contents of which are incorporated herein for all purposes by this reference.

### TECHNICAL FIELD

The present disclosure relates to a multipurpose assembly-type vehicle and a method for operating the same and, more specifically, to a multipurpose assembly-type vehicle having a power connection structure of an architecture concept for implementing an assembly-type vehicle providing various purposes, and a method for operating the same.

### BACKGROUND

Conventional structures other than vehicles have been manufactured and used such that power supply between structures is extended. Such a conventional power extension structure is not available for an assembly-type vehicle providing various purposes, and has a problem in that, when a multipurpose vehicle is assembled, it is impossible to use the power extension structure used by the structure.

In line with recent development of vehicle technologies, there has been increasing development regarding purpose-built vehicles which are mobility vehicles supporting various services. A purpose-built vehicle is an environment-friendly means of transportation capable of providing occupants with various services while moving to a destination, and may have unlimited areas of application, such as mass transportation, distribution industries, and robotaxis.

In addition, there is an increasing demand for technologies regarding architecture vehicles which are systems for providing various functions between vehicles connected to each other in a modular type, and there have been extensive efforts to develop technologies regarding inter-vehicle power extension structures for actual commercialization.

The above descriptions regarding background technologies have been made only to help understanding of the background of the present disclosure, and are not to be deemed by those skilled in the art to correspond to already-known prior arts.

### SUMMARY

It is an aspect of the present disclosure to provide a multipurpose assembly-type vehicle and a method for operating the same, wherein the multipurpose assembly-type vehicle has a power connection structure of an architecture concept for implementing an assembly-type vehicle providing various purposes such that the same has a potential to be extended to various types of vehicle systems.

In accordance with an aspect, the present disclosure provides a multipurpose assembly-type vehicle including: a chassis module including multiple floor parts constituting a lower portion of the vehicle, each floor part being able to exchange electric power or data with an adjacent floor part when fastened to each other; and a cabin module including multiple cabin parts constituting an upper portion of the vehicle, each cabin part being fastened to a corresponding floor part of the lower portion so as to constitute an indoor space, and each cabin part being able to exchange electric power or data with the floor part or with another cabin part adjacent thereto.

The cabin module may include a front cabin part, a center cabin part, and a rear cabin part, and each of side portions of the cabin parts coupled to each other may have an identical shape.

A cabin line through which an electric signal or current flows may be provided in an outer wall constituting the cabin part, cabin connectors may be provided on side portions of the cabin parts coupled to each other and on a bottom portion of the cabin part to which the floor part is coupled, and the cabin line of the cabin part may be connected to the cabin connectors.

The cabin connector may be configured to enable exchange of electric power or data between the cabin parts through a power connection structure, and the cabin parts may be coupled to each other through a fastening hook structure configured to surround the electric power connection structure.

The cabin line may include a cabin connector connection line configured to connect the cabin connectors being spaced apart from and facing each other and a cabin cross line configured to connect the cabin connector connection lines being spaced apart from each other, and a cabin line bus may be provided at a cross point of the cabin connector connection line and the cabin cross line.

A floor line configured to allow an electric signal or current to flow therethrough may be provided inside the floor part, floor connectors may be provided on side portions of the floor parts coupled to each other and on a top portion of the floor part to which the cabin part is coupled, and the floor line of the floor part may be connected to the floor connectors.

The floor connector may be configured to allow the floor parts to be connected to each other through a fastening hook structure.

The floor line may include a floor connector connection line configured to connect the floor connectors being spaced apart from and facing each other and a floor cross line configured to connect the floor connector connection lines being spaced apart from each other, and a floor line bus may be provided at a cross point of the floor connector connection line and the floor cross line.

A branch connector configured to allow an external electronic device to be connected thereto may be provided on an inner side or an outer side of the cabin part, and the branch connector may be connected to a cabin line through a branch line.

Cabin controllers may be provided in the cabin parts, respectively, and the cabin controllers may be configured to communicate with each other through a communication line separated and independent from the cabin line.

The multiple cabin controllers may be configured to communicate with each other in a wireless manner.

The cabin controller and the cabin line may be configured to communicate with each other in a wired manner.

The cabin controller and the cabin line may be configured to communicate with each other in a wireless manner.

When the cabin line of another cabin part adjacent to fails, the cabin controller may be configured to recognize the failure of the communication line and then to enter into a safety mode.

When entering into the safety mode, the cabin controller may be configured to control such that power is received from the floor part to which the corresponding cabin part is directly connected.

In accordance with another aspect, the present disclosure provides a method for operating a multipurpose assembly-type vehicle, the method including: recognizing a user in the multipurpose assembly-type vehicle; activating a server after recognizing the user and requesting a correction to a chassis module; stopping a supply of power to the chassis module in a case of having requested the correction and determining a position of the chassis module; and storing the determined position of the chassis module in a memory.

The method may further include determining whether communication between multiple cabin controllers through a communication line is normal after the storing in the memory.

The method may further include updating a software of the chassis module after determining that the communication is normal.

The method may further include sending connection information to the user after determining that the communication is not normal.

A multipurpose assembly-type vehicle having a power connection structure of an architecture concept for implementing an assembly-type vehicle providing various purposes, and a method for operating the same, are advantageous in that the same can be extended to various types of vehicle systems.

Advantageous effects obtainable from the present disclosure are not limited to the above-mentioned advantageous effects, and other advantageous effects not mentioned herein will be clearly understood by those skilled in the art to which the present disclosure pertains.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a view illustrating a multipurpose assembly-type vehicle according to an embodiment of the present disclosure;

FIG. 2 is a view illustrating a floor part and a cabin part constituting a chassis module and a cabin module of a multipurpose assembly-type vehicle;

FIG. 3 is a view illustrating a structure of a cabin line bus and a floor line bus;

FIG. 4 is a view illustrating a structure of each of a cabin connector and a floor connector;

FIG. 5 is a view illustrating a power connection structure through a connection between a cabin line and a branch line;

FIG. 6 is view illustrating a communication structure through a communication line between a cabin controller and a cabin line;

FIG. 7 is view illustrating a communication structure through a communication line in which a communication structure of FIG. 6 is expanded;

FIG. 8 is a view illustrating a cabin module in which multiple center cabin parts are coupled to each other; and

FIG. 9 is a flowchart illustrating an operation of a multipurpose assembly-type vehicle of FIG. 1.

### DETAILED DESCRIPTION OF THE EXEMPLARY EMBODIMENTS

Specific structural and functional expressions applied to embodiments of the present disclosure disclosed in the specification or the application may be merely an example for the purpose for explaining the embodiments of the present disclosure. Therefore, the embodiments of the present disclosure may be modified in various forms, and it should not be interpreted that the embodiments of the present disclosure are limited by the embodiments disclosed in the specification or the application. Hereinafter, the embodiments of the present disclosure will be described in detail with reference to the accompanying drawings.

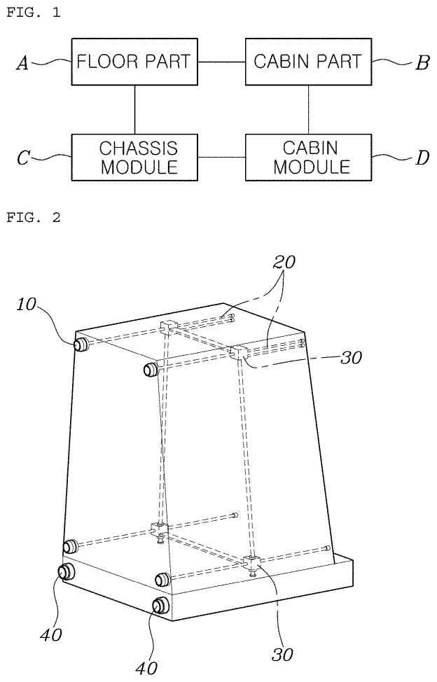

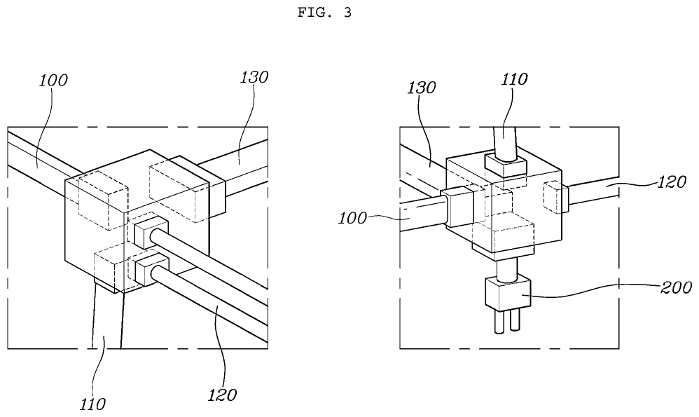

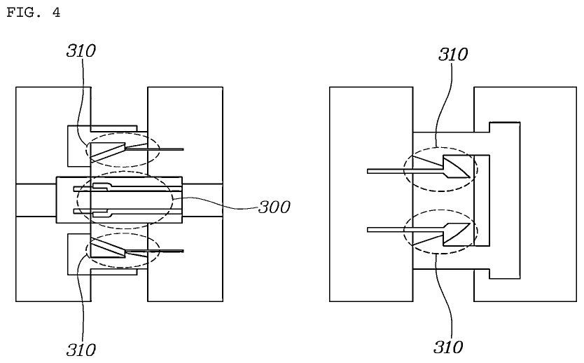

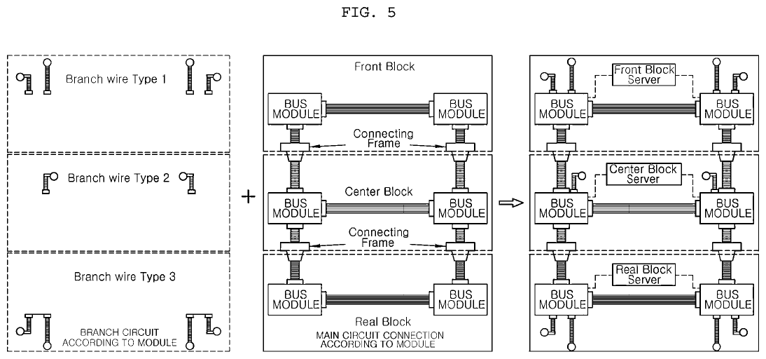

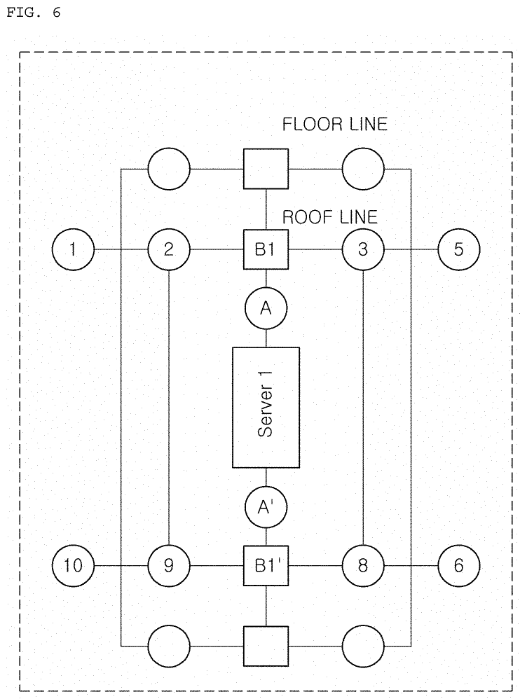

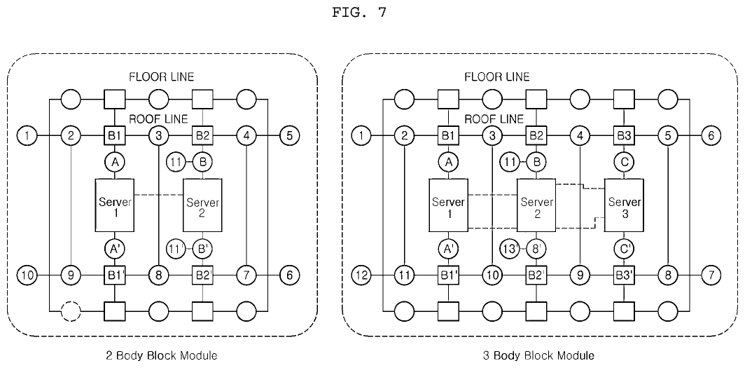

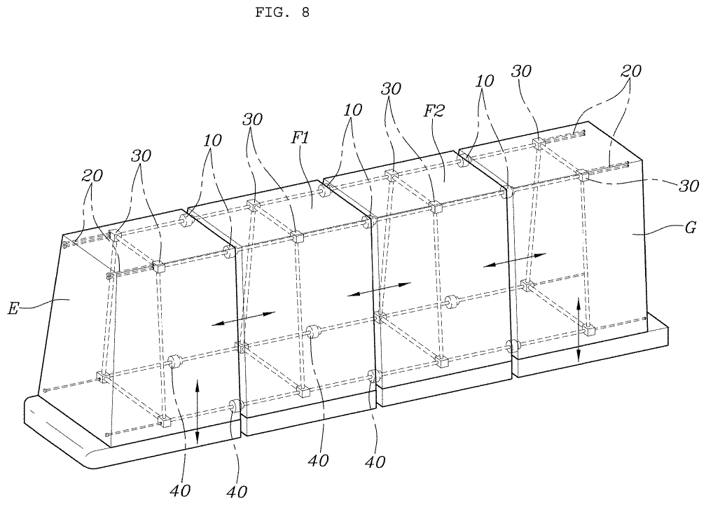

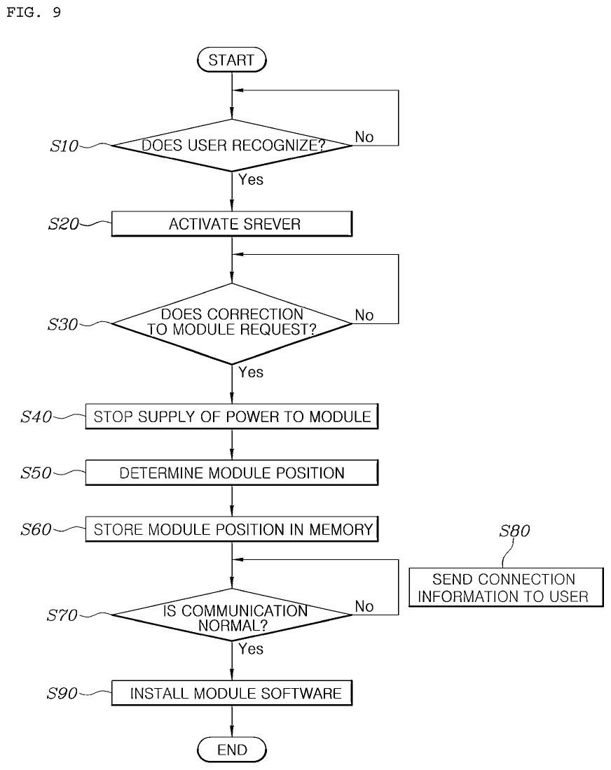

FIG. 1 is a view illustrating a multipurpose assembly-type vehicle according to an embodiment of the present disclosure. FIG. 2 is a view illustrating a floor part and a cabin part respectively constituting a chassis module and a cabin module of a multipurpose assembly-type vehicle. FIG. 3 is a view illustrating a structure of a cabin line bus and a floor line bus. FIG. 4 is a view illustrating a structure of each of a cabin connector and a floor connector. FIG. 5 is a view illustrating a power connection structure through a connection between a cabin line and a branch line. FIG. 6 is view illustrating a communication structure through a communication line between a cabin controller and a cabin line. FIG. 7 is view illustrating a communication structure through a communication line in which a communication structure of FIG. 6 is expanded. FIG. 8 is a view illustrating a cabin module in which multiple center cabin parts are coupled to each other. FIG. 9 is a flowchart illustrating an operation of a multipurpose assembly-type vehicle of FIG. 1.

FIG. 1 is a view illustrating a multipurpose assembly-type vehicle according to an embodiment of the present disclosure. FIG. 2 is a view illustrating a floor part A and a cabin part B constituting a chassis module C and a cabin module D of a multipurpose assembly-type vehicle. Referring to FIGS. 1 and 2, a multipurpose assembly-type vehicle may include: a chassis module C including multiple floor parts A constituting a lower portion of a vehicle, each floor part A being able to exchange of electric power or data with when fastened to each other; and a cabin module D including multiple cabin parts B constituting an upper portion of the vehicle, each cabin part B being fastened to a corresponding floor part A of the lower portion so as to form an indoor space, each cabin part B being able to exchange electric power or data with the floor part or with another cabin part adjacent thereto.

The present disclosure may provide a multipurpose assembly-type vehicle having a possibility being able to expand to various types of vehicle systems by using a power connection structure according to an architecture concept for implementing an assembled vehicle capable of providing various uses. To this end, it needs an environment in which electric power or data can be exchanged between unit vehicles constituting a multipurpose assembly-type vehicle.

The exchange of electric power or data may be mainly performed in a structure rather than a vehicle through expansion of power source between structures. Electric power or data exchange between structures rather than vehicles may only be done in a fixed state. Therefore, there may be a problem that the method of electric power or data exchange between structures rather than vehicles cannot be used in an assembled vehicle capable of being used for multi purposes. Accordingly, it should be possible to exchange electric power or data between the floor parts A and the cabin parts B constituting a multipurpose assembly-type vehicle so that the necessity of harmoniously operating an assembled vehicle can be satisfied. In addition, it may be necessary that electric power or data exchange is done through an architecture type for providing various functions connected to each other.

However, a multipurpose assembly-type vehicle, differently from a structure, may be formed by assembling between unit vehicles to achieve a necessary purpose, and accordingly it should be possible to exchange electric power or data between the unit vehicles. In addition, a multipurpose assembly-type vehicle may be formed by assembling between unit vehicles through horizontal or vertical coupling thereof, and accordingly it should be possible to exchange electric power or data horizontally or vertically between the unit vehicles. In order to possibly exchange electric power or data horizontally or vertically in an assembled vehicle, a connection structure allowing power to pass therethrough may be formed, and thus the connection structure may be connected, through a connector structure, to a line through which an electric signal or current flows. In an assembled vehicle, upper portions of unit vehicles having the same purpose may be connected to each other so that it is possible not only to control ON of an interior lighting of a vehicle but also to use an assembled vehicle according to the original purpose thereof, and thus it is essential to exchange electric power or data. In addition, a lower portion of an assembled vehicle may be fastened to an upper portion of the assembled vehicle, and thus it is essential to exchange electric power or data between an upper part of an assembled vehicle and a lower part of the assembled vehicle.

To this end, the present disclosure may include an indoor space formed by the cabin part B constituting an upper portion of the multipurpose assembly-type vehicle and the floor part A constituting a lower portion thereof, and the cabin part B is fastened to a corresponding floor part A. Accordingly, each cabin part B can exchange electric power or data with the floor part A or another cabin part B adjacent thereto each.

Specifically, a chassis module C constituting a multipurpose assembly-type vehicle may include the multiple floor parts A constituting a lower portion of a vehicle, and the floor parts A can exchange electric power or data with each other when fastened to each other. Although the floor parts A can exchange electric power or data with each other when fastened to each other, the connection between the floor parts A may be connected by a connector which does not have a power connection structure 300 in consideration of a battery-as-a-service. In this case, a connector of the floor part A is configured to allow the floor parts A to be coupled to each other by a fastening catch structure 310. The floor parts A may be horizontally coupled to each other to support the cabin parts B at the lower portion thereof, and may be configured to have a movable system built on the bottom thereof. In a case in which a movable system is built on the bottom thereof, the chassis module C can move according to the movable system even in a case of using various functions expanded by the assembly of the multiple cabin parts B.

The cabin module D constituting a multipurpose assembly-type vehicle may be positioned above the chassis module C, and the cabin module D may include the multiple cabin parts B. Each cabin part B may be fastened to the corresponding floor part A and be positioned thereunder, so as to form an indoor space, and thus the cabin part B may be configured to enable the exchange of electric power or data with the floor part A or the cabin part B adjacent thereto. The cabin part B may have an inner space, and the cabin part B may be configured to perform a car-hailing which is a type of mobility services connecting, in real time, a consumer who wants to move and a mobile service provider. The cabin part B may be implemented for various purposes such as performing a delivery service wherein a consumer puts food to deliver in an inner space thereof and performing a robotaxi function in which an autonomous vehicle service and a taxi service are combined. The cabin part B, which may be used for such various purposes, may be used as an expanded purpose in the cabin module D including the multiple cabin parts B. In a case where there are many consumers who want to move, there is much food to be delivered by a consumer, or there are many passengers who want to use the service of a taxi driven by autonomous driving, the multiple cabin parts B may be horizontally connected to each other so as to expand in a required purpose and be used.

If it is not possible to exchange electric power or data between the cabin parts B through the power connection structure 300 in a case where the multiple cabin parts B are horizontally connected to each other and are used for an appropriate purpose expanded according to a required purpose, the cabin parts B may perform a function independently from each other and thus it is difficult to achieve the purpose of expanding in a vehicle system according to various types. The cabin part B may be a portion which is connected to an upper portion in a multipurpose assembly-type vehicle and thus it is essential to exchange electric power or data with another cabin part B adjacent thereto in a case where the multiple cabin parts B are connected to each other. In addition, the cabin part B may be configured to exchange electric power or data with the floor part A and to thus interlink with the floor part B through a cabin controller inside the cabin part A.

FIG. 2 is a view illustrating a floor part A and a cabin part B constituting a chassis module C and a cabin module D of a multipurpose assembly-type vehicle. FIG. 8 is a view illustrating a cabin module in which multiple center cabin parts are coupled to each other.

Referring to FIG. 2 and FIG. 8, FIG. 2 illustrates a type of a multipurpose assembly-type vehicle including cabin part B and a floor part A. The cabin module D may include a front cabin part, a center cabin part, and a rear cabin part, and each of side portions of the cabin parts B coupled to each other is configured to have the same shape.

The cabin module D may include a front cabin part disposed at the most front side, a rear cabin part disposed at the most rear side, and a center cabin part disposed between the front cabin part and the rear cabin part. The center cabin part may mean all the cabin parts B arranged between the front cabin parts and the rear cabin parts. The center cabin part may be connected to the front cabin part and the rear cabin part, the cabin parts B may be connected to each other through a cabin connector 10, and the floor parts A may be connected to each other through a floor connector 40. In addition, in the center cabin part disposed between the front cabin part and the rear cabin part, the center cabin part may have side portions which are respectively coupled thereto and have the same shape, and one or more center cabin part may be coupled therebetween. Only the case where the side portions coupled each other has the same shape, the front cabin part and the rear cabin part which are connected to the center cabin part may be connected to another cabin part B through the cabin connectors 10, and the floor parts A may be connected to each other through the floor connectors 40. The structure illustrated in FIG. 2 shows the front cabin part or the rear cabin part. Side surfaces to which a cabin line bus 30 and a floor line bus 30 are connected may be connected to each other through a branch line 20, and the other side surfaces are connected to each other through a cabin line. The center cabin part may have side portions which are coupled thereto and have the same shape, and thus it is possible to exchange electric power or data through the cabin connector 10 in a case of connecting the center cabin part, the front cabin part, or the rear cabin part to the side surfaces thereof. The front cabin part and the rear cabin part may have a structure symmetric to each other and the side portions thereof may be configured to have the same shape. Therefore, the front cabin part and the rear cabin part can implement an architecture which has a modular shape and is connected to each other. In addition, the cabin part B may include, without the center cabin part, only the front cabin part and the rear part, and the front cabin part and the rear cabin part may have a structure symmetric to each other even in the case where the cabin part B does not include the center cabin part. Referring to FIG. 8, the cabin part B including the center cabin part, the front cabin part, and the rear part may constitute one multipurpose assembly-type vehicle by multiple center cabin parts connected to each other between the front cabin part and the rear cabin. Accordingly, two or more the center cabin parts may be coupled to each other.

An outer wall forming the cabin part B may be provided with a cabin line through which an electrical signal or current flows, the side portions of the cabin parts B, which are coupled to each other, and the lower end of the cabin part B, which are coupled to the floor part A, may be provided with the cabin connectors 10, and the cabin line of the cabin part B may be connected to the multiple cabin connectors 10.

Referring to FIG. 3, the outer wall forming the cabin part B may be provided with the cabin line through which an electrical signal or current flows so that an electrical signal or current flows through the cabin part B provided with the cabin line. The cabin line may be connected to the cabin connector 10 provided on the side portions to which the center cabin part, the front cabin part, or the rear cabin part are coupled to each other, so as to enable electric power or data exchange between the center cabin part, the front cabin part, or the rear cabin part. In addition, the cabin connector 10 may be also provided at the lower end of the cabin part B to which the floor part A is coupled, so as to enable electric power or data exchange between the center cabin part, the front cabin part, or the rear cabin part.

FIG. 4 is a view illustrating a structure of each of a cabin connector 10 and a floor connector 40.

Referring to FIG. 4, the cabin connector 10 of the left view may be configured to allow electric power or data exchange between the cabins B through the power connection structure 300, and the cabin parts B may be coupled to each other through the fastening catch structure 310, which is configured to surround the power connection structure 300.

In order that the center cabin part, the front cabin part, or the rear cabin part are coupled to each other, electric power or data should be exchanged through the connector 10. In this case, when the cabin connector 10 may form the power connection structure 300 between the cabin parts B of a multipurpose assembly-type vehicle, it is possible to exchange electric power or data between the cabin parts B. A positive power source connected to a negative terminal and a negative power source connected to a positive terminal inside the power connection structure 300 may be connected to each other so as to enable the exchange of electric power or data between the cabin parts B. The cabin connector 10 may be configured to enable the cabin lines facing each other while being spaced apart from each other to be connected through the power connection structure 300 so that the exchange of electric power or data between the cabin parts B is possible. The floor connector 40 of the right view of FIG. 4 may have only the fastening catch structure 310 without the power connection structure 300, and may adopt a so-called decoupling structure. The floor connector 40 adopting a decoupling structure may independently receive power regardless of a specific floor part A when the floor parts A are coupled to each other. In the case where the power connection structure 300 is not formed between the floor parts A differently from the cabin connector 10, the connection between the floor parts A may be independently configured in consideration of easy disassembly of a multipurpose assembly-type vehicle according to whether to adopt a battery-as-a-service and the like. Accordingly, the floor connector 40 may be configured to allow the connections between the floor parts A to be independently formed, and the floor parts A may be coupled to each other by the fastening catch structure 310 without the power connection structure 300. In addition, both the cabin connector 10 and the floor connector 40 may be configured to allow the cabin parts B to be coupled to each other through the fastening catch structure 310. The fastening catch structure 310 of the cabin connector 10 and the floor connector 40 illustrated in FIG. 4 may be a type of a fastening structure and may be a holding structure for preventing the coupling between the cabin parts B or between the floor parts A from being separated from each other. When the fastening catch structure 310 is pulled outward in a coupled state, the fastening catch structure 310 may not be separated by a stronger fixation force generated therebetween, whereas when pushed toward each other, the fastening catch structure 310 may move naturally. In the case where the fastening catch structure 310 moves naturally, it may be possible to form an assembled vehicle according to a required purpose after separating the chassis module C and the cabin module D by using an electric or a manual method. A coupling structure constituting the cabin connector 10 may be applied to a vertical coupling portion between the cabin part B and the floor part A, be applied to a horizontal coupling portion between the front cabin part, the center cabin part, and the rear cabin part constituting the cabin part B, or be applied to a horizontal coupling portion between the front cabin part and the rear cabin part in the case of not including the center cabin part. In addition, a seal may be formed on an outer side of the fastening catch structure 310 in the cabin connector 10, and the seal may be a structure for preventing the abrasion of a component by causing the component to hold a sealant having a rubber film formed the surface thereon. Specifically, the seal structure may be a type of a sealing method for preventing the invasion of a foreign material from the outside or the leakage of a foreign material such as oil into the inside when a component is assembled and coupled. A seal may be formed on an outer side of the fastening catch structure 310, and in connection with the cabin connector 10, the fastening catch structure 310 may be formed on an outer side of the power connection structure 300. Namely, a seal may be formed on an outer side of the fastening catch structure 310, and thus the power connection structure 300 and the fastening catch structure 310 surrounded by the seal may be prevented from external impact and abrasion.

FIG. 3 is a view illustrating a structure of a cabin line bus 30 and a floor line bus 30.

Referring to FIG. 3, a cabin line may include a cabin connector connection line 100 which is configured to connect the cabin connectors 10 facing each other while being spaced apart from each other and a cabin cross line 130 which is configured to connect the cabin connector connection lines 110 spaced apart from each other, and the cabin line bus 30 may be provided at a cross point between the cabin connector connection line 100 and the cabin cross line 130.

The cabin line bus 30 and the floor line bus 30 may be a system bus and be a type of channel to enable hardware devices to communicate each other. The cabin line bus 30 may be provided in the cabin line connector 10 and at a cross point between the cabin connector connection line 100 and the cabin cross line 130, and the cabin line bus 30 may be configured to function as a path between the cabin connector connection line 100 and the cabin cross line 130 which are included in a cabin line through which an electrical signal or current flows such that electric power or data can be exchanged. In the case where multiple cabin line buses 30 are arranged on an upper portion of a multipurpose assembly-type vehicle, the cabin connectors 10 may be connected to each other through the cabin connector connection lines 100, and the connection between the multiple cabin line buses 30 may be connected through the cabin cross lines 130. In addition, the outer side or the inner side of the cabin part B may be connected through a cabin line and the branch line 20, and thus power may be connected through the branch line 20 connected to the cabin line bus 30. Referring to FIG. 3, one of the left configuration or the right configuration may be configured according to a position of a bus module. The branch line 20 connected to the floor part A may have a structure capable of exchanging electric power or data from the chassis module C to the cabin module D.

A floor line through which an electrical signal or current flows may be provided inside the floor part A, the floor connector 40 may be provided on side portions in which the floor parts A are coupled to each other and an upper end of the floor part A to which the cabin part is coupled, and the floor line of the floor part A may be connected to the multiple floor connectors 40.

Referring to FIG. 2, the floor line may be provided at a lower end of the cabin module D so that an electrical signal or current flows through the floor part A provided with the floor line. The chassis module C may include a center floor part, a front floor part, or a rear floor part. The floor line may be connected to the floor connectors 40 provided on the side portions to which the center floor part, the front floor part, or the rear floor part are coupled each other, so as to enable electric power or data exchange between the center floor part, the front floor part, or the rear floor part. In the case where the power connection structure 300 is not formed therein, the connections between the floor parts A may be independently configured in consideration of easy disassembly of a multipurpose assembly-type vehicle according to whether to adopt a battery-as-a-service and the like. The floor connectors 40 may be provided on side portions in which the floor parts A are coupled to each other and an upper end of the floor part A to which the cabin part B is coupled, and the floor line of the floor part A may be connected to the multiple floor connectors 40.

The floor connector 40 may be configured to allow the floor parts A to be coupled to each other by the fastening catch structure 310.

Referring to FIG. 4, the floor connector 40 of the right view may have only the fastening catch structure 310 without the power connection structure 300, and so called may adopt a decoupling structure. The floor connector 40 adopting a decoupling structure may independently receive power regardless of a specific floor parts A when the floor parts A are coupled to each other. In the case where the power connection structure 300 is not formed between the floor part A differently from the cabin connector 10, the connection between the floor parts A may be independently configured in consideration of easy disassembly of a multipurpose assembly-type vehicle according to whether to adopt a battery-as-a-service and the like. Accordingly, the floor connector 40 may be configured to allow the connections between the floor parts A to be independently formed, and thus the floor parts A may be coupled to each other by the fastening catch structure 310 without the power connection structure 300. In addition, both the cabin connector 10 and the floor connector 40 may be configured to allow the cabin parts B to be coupled to each other through the fastening catch structure 310. The fastening catch structure 310 of the cabin connector 10 and the floor connector 40 illustrated in FIG. 4 may be a type of a fastening structure and may be a holding structure for preventing the coupling between the cabin parts B and between the floor parts A from being separated from each other. When the fastening catch structure 310 is pulled outward in the coupled state, the fastening catch structure 310 may not be separated by a stronger fixation force generated therebetween, whereas when pushed toward each other, the fastening catch structure 310 may move naturally. In the case where the fastening catch structure 310 moves naturally, it may be possible to form an assembled vehicle according to a required purpose after separating the chassis module C and the cabin module D by using an electric or a manual method. The coupling structure constituting the cabin connector 10 may be applied to a vertical coupling portion between the cabin part B and the floor part A, be applied to a horizontal coupling portion between the front cabin part, the center cabin part, and the rear cabin part constituting the cabin part B, or be applied to a horizontal coupling portion between the front cabin part and the rear cabin part in the case of not including the center cabin part. On the other hand, a decoupling structure constituting the floor connector 40 may be applied to a horizontal coupling portion between the floor parts A. In addition, a seal may be formed on an outer side of the fastening catch structure 310 in the floor connector 40, and in the cabin connector 10, the fastening catch structure 310 may be formed on an outer side of the power connection structure 300. Namely, a seal may be formed on an outer side of the fastening catch structure 310, and thus the power connection structure 300 and the fastening catch structure 310 surrounded by the seal may be prevented from external impact and abrasion.

The floor line may include floor connector connection line 100 which is configured to connect the floor connectors 40 facing each other while being spaced apart from each other and a floor cross line 130 which is configured to connect the floor connector connection lines 100 spaced apart from each other, and a floor line bus 30 may be provided at a cross point between the floor connector connection line 100 and the floor cross line 130.

The floor line bus 30 may be a system bus and be a type of channel to enable hardware devices to communicate each other. The floor line may include a floor connector connection line 100 which are configured to connect the floor connectors 40 facing each other while being spaced apart from each other and a floor cross line 130 which is configured to connect the floor connector connection lines 100 spaced apart from each other. In the case where multiple floor line bus 30 is arranged on a lower portion of a multipurpose assembly-type vehicle, the floor connector 40 may be connected through the floor connector connection line 100, and the connection between the multiple floor line buses 30 may be connected through the floor cross line 130. In addition, the outer side or the inner side of the floor part A may be connected through the floor line and the branch line 20, and thus power may be connected through the branch line 20 connected to the floor line bus 30. Referring to FIG. 3, one of the left configuration or the right configuration may be configured according to a position of a bus module. The branch line 200 connected to the floor part A may have a structure capable of exchanging electric power or data from the chassis module C to the cabin module D.

FIG. 5 is a view illustrating a power connection structure through a connection between a cabin line and a branch line 20.

Referring FIG. 5, a branch connector to which an external electronic device is connected may be provided on an inner side or an outer side of the cabin part B, and the branch connector may be connected through the cabin line and the branch line 20.

The branch line 20 may be arranged on a branch circuit of the cabin module D to supply electric power or data to a part of a multipurpose assembly-type vehicle requiring the exchange of electric power or data in an inner side or outer side of the cabin part B. The branch line 20 passing through the cabin line bus 30 may be connected to the cabin line, and be connected through the branch connector. The branch line 20 may be branched from the branch circuit of the cabin line and exchange electric power or data with the inner side or outer side of the cabin part B which does not exchange electric power or data with the cabin line. Therefore, the ON or OFF of the interior lighting or exterior lighting of a vehicle can be controlled, or electric power or data can be supplied to a part requiring the exchange of electric power or data, such as a data exchange by supplying the power to a display device inside a multipurpose assembly-type vehicle.

FIG. 6 is view illustrating a communication structure through a communication line between a cabin controller and a cabin line. FIG. 7 is view illustrating a communication structure through a communication line in which a communication structure of FIG. 6 is expanded.

Referring to FIG. 5, FIG. 6, and FIG. 7, a cabin controller may be provided in each of the cabin parts B, and the multiple cabin controllers may be configured to communicate with each other through an independent communication line which is separated from the cabin line.

When the branch circuit and the main circuit are connected, the cabin controller may form a communication structure which allows the cabin modules D to communicate with each other, and the chassis module C may be connected to the cabin line bus 30 and the floor line bus 30 to enable the exchange of electric power or data. Referring to FIG. 6, the cabin controller may function as the connection of the main circuit to the branch circuit, the main circuit connected to the cabin line may be a closed circuit connected in the order of 2-B1-3-8-B1′-9-2f, and a three-dimensional connection of the main circuit in the floor line may be formed by a vertical connection through the cabin line of the upper end B1 and the lower end B1 in the closed circuit. In addition, the branch circuit connected to the branch line 20 may exchange electric power or data with the inner side or outer side of the cabin part B through the branch circuits 1, 10, 5, and 6. Therefore, the ON or OFF of the interior lighting or exterior lighting of a vehicle can be controlled, or electric power or data can be supplied to a part requiring the exchange of electric power or data, such as a data exchange by supplying the power to a display device inside a multipurpose assembly-type vehicle. In addition, the communication structure which allows the cabin modules D to communicate with each other illustrated in FIG. 6 may have an expanded power circuit as illustrated in FIG. 7. When the power circuit is expanded, the multiple cabin modules D may communicate with each other.

The multiple cabin controllers may communicate with each other in a wireless manner.

The cabin controllers may be respectively arranged in the cabin parts B and be configured to communicate with each other through independent communication lines separated from the cabin line, and may control such that the cabin parts B communicate with each other through a wireless manner such as ultra-wideband (UWB) or a bluetooth communication. In a case where the cabin controller, as the power connection structure 300 of the cabin connector 10, controls to communicate in a wired manner, when the power connection structure 300 of the cabin connector 10 fails or the cabin parts B are spaced apart from each other, a situation that it is difficult to communicate between one cabin controller and another cabin controller may occur. Accordingly, the multiple cabin controllers may be installed to communicate with each other in a wireless manner without installing a separate device in the cabin connector 10.

The cabin controller and the cabin line may communicate with each other in a wired manner or in a wireless manner.

The cabin controller and the cabin line may be configured to communicate with each other in wired manner or in a wireless manner. Therefore, when wired communication is impossible, the cabin controller and the cabin line may be configured to communicate in a wireless manner, and when wireless communication is impossible, the cabin controller and the cabin line may be configured to communicate in wired manner. The cabin controller and the cabin line may be arranged in each of the front cabin part, the center cabin part, and the rear cabin part and be used, and in one cabin part B, the cabin controller is connected to the cabin line and can operate. Accordingly, the cabin controller disposed in one cabin part B and the cabin line enabling the exchange of electric power or data in one cabin part B may be controlled to enable a wired communication even in a case where wireless communication is difficult.

The cabin controller may be configured to recognize failure of a communication line when the cabin line of another cabin part B adjacent thereto fails and then to enter into a safety mode. When entering into the safety mode, the cabin controller may control to receive power from the floor part A to which the corresponding cabin part A is directly connected.

The safety mode may mean a fail-safe and may mean a method which is configured such that the cabin controller is surely shifted into a safe mode when a device or an apparatus malfunctions. In the case where the cabin part B malfunctions or fails, the communication with another cabin part B is difficult. Therefore, an original purpose to be achieved by a multipurpose assembly-type vehicle cannot be achieved. For example, if it is not possible to completely achieve a car-hailing function, a delivery function, or a robotaxi function and it is difficult to operate a multipurpose assembly-type vehicle, the multipurpose assembly-type vehicle may be in a serious state. A cabin part B, through the cabin connector 10, may be connected to another cabin part B adjacent thereto by the power connection structure 300 and may receive power, but the cabin part B cannot receive power through another cabin part B adjacent thereto and the power connection structure 300 when the cabin part B fails. Accordingly, in the case where the cabin line of the cabin part B of a multipurpose assembly-type vehicle fails, the cabin controller may be configured to recognize the failure of the cabin line and to receive power from the floor part A vertically connected to the cabin part B so as to control the cabin part B.

FIG. 9 is a flowchart illustrating an operation of a multipurpose assembly-type vehicle of FIG. 1.

Referring to FIG. 9, provided may be a method for operating a multipurpose assembly-type vehicle, the method including: a step S10 of recognizing a user in a multipurpose assembly-type vehicle; a step S20 of activating a server after recognizing the user and a step S30 of requesting a correction to a chassis module C; a step S40 of stopping a supply of power in a case of having requested the correction to the a chassis module C and a step S50 of determining a position of the chassis module C; and a step S60 of storing the determined position of the chassis module in a memory.

After the step S60 of storing in the memory, a step S70 of determining whether a communication between multiple cabin controllers through a communication line is normal may be further included.

After the step S70 of determining whether the communication between the multiple cabin controllers through the communication line is normal, a step S90 of updating a software of the chassis module C in a case where the communication is normal may be further included.

After the step S70 of determining whether the communication between the multiple cabin controllers through the communication line is normal, a step S80 of sending connection information to a user in a case where the communication is not normal may be further included.

The controller may include a processor or a microprocessor. Optionally, the controller may also include a memory. The aforementioned operations/functions of the controller can be embodied as computer readable code/algorithm/software stored on the memory thereof which may include a non-transitory computer readable recording medium. The non-transitory computer readable recording medium is any data storage device that can store data which can thereafter be read by the processor or the microprocessor. Examples of the computer readable recording medium include a hard disk drive (HDD), a solid state drive (SSD), a silicon disc drive (SDD), read-only memory (ROM), random-access memory (RAM), CD-ROM, magnetic tapes, floppy disks, optical data storage devices, etc. The processor or the microprocessor may perform the above described operations/functions of the controller, by executing the computer readable code/algorithm/software stored on the non-transitory computer readable recording medium.

Although a specific embodiment of the present disclosure has been described and illustrated, it is apparent to those skilled in the art that the present disclosure may be changed and modified in various ways without departing from the scope of the technical idea of the present disclosure provided by the claims.

What is claimed is:

1. A multipurpose assembly-type vehicle comprising:
a chassis module comprising multiple floor parts constituting a lower portion of the vehicle, each floor part being able to exchange electric power or data with an adjacent floor part when fastened to each other; and
a cabin module comprising multiple cabin parts constituting an upper portion of the vehicle, each cabin part being fastened to a corresponding floor part of the lower portion so as to constitute an indoor space, and each cabin part being able to exchange electric power or data with the floor part or with another cabin part adjacent thereto.

2. The multipurpose assembly-type vehicle of claim 1, wherein the cabin module comprises a front cabin part, a center cabin part, and a rear cabin part, and each of side portions of the cabin parts coupled to each other has an identical shape.

3. The multipurpose assembly-type vehicle of claim 1, wherein a cabin line through which an electric signal or current flows is provided in an outer wall constituting the cabin part, cabin connectors are provided on side portions of the cabin parts coupled to each other and on a bottom portion of the cabin part to which the floor part is coupled, and the cabin line of the cabin part is connected to the cabin connectors.

4. The multipurpose assembly-type vehicle of claim 3, wherein the cabin connector is configured to enable exchange of electric power or data between the cabin parts through a power connection structure, and the cabin parts are coupled to each other through a fastening hook structure configured to surround the electric power connection structure.

5. The multipurpose assembly-type vehicle of claim 3, wherein the cabin line comprises a cabin connector connection line configured to connect the cabin connectors being spaced apart from and facing each other and a cabin cross line configured to connect the cabin connector connection lines being spaced apart from each other, and a cabin line bus is provided at a cross point of the cabin connector connection line and the cabin cross line.

6. The multipurpose assembly-type vehicle of claim 1, wherein a floor line configured to allow an electric signal or current to flow therethrough is provided inside the floor part, floor connectors are provided on side portions of the floor parts coupled to each other and on a top portion of the floor part to which the cabin part is coupled, and the floor line of the floor part is connected to the floor connectors.

7. The multipurpose assembly-type vehicle of claim 6, wherein the floor connector is configured to allow the floor parts to be connected to each other through a fastening hook structure.

8. The multipurpose assembly-type vehicle of claim 6, wherein the floor line comprises a floor connector connection line configured to connect the floor connectors being spaced apart from and facing each other and a floor cross line configured to connect the floor connector connection lines being spaced apart from each other, and a floor line bus is provided at a cross point of the floor connector connection line and the floor cross line.

9. The multipurpose assembly-type vehicle of claim 1, wherein a branch connector configured to allow an external electronic device to be connected thereto is provided on an inner side or an outer side of the cabin part, and the branch connector is connected to a cabin line through a branch line.

10. The multipurpose assembly-type vehicle of claim 1, wherein cabin controllers are provided in the cabin parts, respectively, and the cabin controllers are configured to communicate with each other through a communication line separated and independent from the cabin line.

11. The multipurpose assembly-type vehicle of claim 10, wherein the cabin controllers are configured to communicate with each other in a wireless manner.

12. The multipurpose assembly-type vehicle of claim 10, wherein the cabin controller and the cabin line are configured to communicate with each other in a wired manner.

13. The multipurpose assembly-type vehicle of claim 10, wherein the cabin controller and the cabin line are configured to communicate with each other in a wireless manner.

14. The multipurpose assembly-type vehicle of claim 10, wherein when the cabin line of another cabin part adjacent to fails, the cabin controller is configured to recognize the failure of the communication line and then to enter into a safety mode.

15. The multipurpose assembly-type vehicle of claim 10, wherein when entering into the safety mode, the cabin controller is configured to control such that power is received from the floor part to which the corresponding cabin part is directly connected.

16. A method for operating a multipurpose assembly-type vehicle, the method comprising:
recognizing a user in the multipurpose assembly-type vehicle;
activating a server after recognizing the user and requesting a correction to a chassis module;
stopping a supply of power to the chassis module in a case of having requested the correction and determining a position of the chassis module; and
storing the determined position of the chassis module in a memory.

17. The method of claim 16, further comprising determining whether communication between multiple cabin controllers through a communication line is normal after the storing in the memory.

18. The method of claim 17, further comprising updating a software of the chassis module after determining that the communication is normal.

19. The method of claim 17, further comprising sending connection information to the user after determining that the communication is not normal.
